(19) United States
(12) Patent Application Publication
(10) Pub. No.: US 2003/0081551 A1
(43) Pub. Date: May 1, 2003

(54) Monitoring equipment for optical digital communications

(75) Inventors: Hiroshi Yazaki, Tokyo (JP); Kazuo Nagata, Tokyo (JP); Toshiya Mizuta, Tokyo (JP); Sakae Imamura, Tokyo (JP)

Correspondence Address: ARMSTRONG,WESTERMAN & HATTORI, LLP, 1725 K STREET, NW, SUITE 1000, WASHINGTON, DC, 20006, US

(73) Assignee: YOKOGAWA ELECTRIC CORPORATION,, Tokyo (JP)

(21) Appl. No.: 10/254,536

(22) Filed: Sep. 26, 2002

(30) Foreign Application Priority Data
Oct. 29, 2001 (JP) 2001-330423

(51) Int. Cl. H04L 1/00

(52) U.S. Cl. 370/232; 370/253

(57) ABSTRACT

The object of the present invention is to realize monitoring equipment for optical digital communications which can measure the quality of or acquire data in communication networks without reducing the optical power in communication networks.

In the monitoring equipment for optical digital communications which measures the quality of optical digital communication networks to which a plurality of network equipment is connected, the present invention is characterized by having at least one O/E converter that converts optical signals transmitted in an optical digital communication network to electrical signals and at least one E/O converter that converts electrical signals from this O/E converter to optical signals and outputs them to the optical digital communication network and by implementing quality measurement using the output of the above O/E converter.

### BACKGROUND OF THE INVENTION

1. Field of the Invention

The present invention relates to monitoring equipment for optical digital communications, and more precisely, to monitoring equipment for optical digital communications which can measure the quality of or can acquire data in communication networks without reducing the optical power in communication networks.

2. Description of the Prior Art

In communication networks, transmission of digital signals utilizing electricity in copper wires has been changed to transmission of optical digital signals using light in optical fibers instead of copper wires, as the speed of transmission has increased. For example, in the basic part constituting communication networks, optical digital signals are transmitted using communication standards for the synchronous optical network/synchronous digital hierarchy (SONET/SDH). Also, in local area networks (LAN) which are equivalent to local lines of communication networks, Fast Ethernet, (Ethernet: trademark), Gigabit Ethernet, etc. are used. Such communication networks that use light are also called optical digital communication networks.

Monitoring equipment for optical digital communications measures the quality of and acquires data in a communication network by measuring the optical digital signals flowing in the above communication network. Such equipment is called, for example, a Quality of Service (QoS) probe. QoS probes include equipment that measures the quality of a communication network or equipment that only acquires the data of packets flowing in a communication network.

Measurement of quality means to measure the time that is taken by the data of a packet to reach the destination, as well as its dispersion, total amount of packets, number of packets lost due to some cause, etc. by analyzing the data of packets flowing in communication networks. Such equipment is shown in FIG. 1 and will now be described.

In FIG. 1, first network equipment 10 and second network equipment 20 have Gigabit Ethernet ports respectively and are connected so that packet data can be transmitted as optical digital signals (hereafter abbreviated as optical signals) using a pair of optical fibers 30. Optical fibers 30 constitute a digital communication network and the sending data of network equipment 10 (corresponding to the receiving data seen from network equipment 20) and the receiving data of network equipment 10 (corresponding to the sending data seen from network equipment 20) are transmitted to each of connected network equipment 10 and 20 respectively.

Splitter 40 is provided in an arbitrary position of optical fibers 30 and splits optical signals transmitted by optical fibers 30, and outputs the split optical signals to a pair of optical fibers 31. Each element fiber of optical fibers 31 is connected to each element fiber of optical fibers 30 respectively. In many cases, the split ratio of optical signals with splitter 40 from optical fibers 30 to optical fibers 31 is set to 50:50.

Monitoring equipment 50 is composed of first opto-electrical (O/E) converter 51a that converts optical signals to electrical signals, second O/E converter 51b that converts optical signals to electrical signals in the same manner, first physical layer circuit 52a, second physical layer circuit 52b, first media access control address (MAC) layer circuit 53a, second MAC layer circuit 53b, controller 54, and others. In monitoring equipment 50, physical layer circuits 52a and 52b, MAC layer circuits 53a and 53b and controller 54 constitute a measuring part to measure the quality of a communication network using electrical signals. Optical signals which are split by splitter 40 and transmitted through optical fibers 31 are input to monitoring equipment 50.

The input end of first O/E converter 51a is connected to one element fiber of optical fibers 31 through which sending data of network equipment 10 are transmitted. The input end of physical layer circuit 52a is connected to the output end of first O/E converter 51a. The input end of MAC layer circuit 53a is connected to the output end of physical layer circuit 52a and the output end of MAC layer circuit 53a is connected to controller 54.

The input end of second O/E converter 51b is connected to the other element fiber of optical fibers 31 through which sending data of network equipment 20 are transmitted. The input end of physical layer circuit 52b is connected to the output end of second O/E converter 51b. The input end of MAC layer circuit 53b is connected to the output end of physical layer circuit 52b and the output end of MAC layer circuit 53b is connected to controller 54.

The actions of the above equipment will be described below. The sending data from network equipment 10 are split into two groups of approximately the same optical power by splitter 40 provided in the middle of the path of optical fibers 30. One group of the split sending data is transmitted through one element fiber of optical fibers 30 and input to network equipment 20, while the other group is transmitted through one element fiber of optical fibers 31 and input to O/E converter 51a. O/E converter 51a converts optical signals to electrical signals and outputs them to physical layer circuit 52a. Physical layer circuit 52a converts the electrical signals output from O/E converter 51a to logic signals and outputs them to MAC layer circuit 53a. MAC layer circuit 53a acquires the required signals from the logic signals and outputs them to controller 54.

The sending data from network equipment 20 are split into two groups of approximately the same optical power by splitter 40. One group of the split sending data is transmitted through the other element fiber of optical fibers 30 and input to network equipment 10, while the other group is transmitted through the other element fiber of optical fibers 31 and input to O/E converter 51b. O/E converter 51b converts optical signals to electrical signals and outputs them to physical layer circuit 52b. Physical layer circuit 52b converts the signals output from O/E converter 51b to logic signals and outputs them to MAC layer circuit 53b. MAC layer circuit 53b acquires the required signals from the logic signals and outputs them to controller 54.

Controller 54 measures the quality of the above communication network using output signals from either one or both of MAC layer circuits 53a and 53b.

In addition, another example of conventional systems will be described below with reference to FIG. 2. In FIG. 2, components which are the same as those in FIG. 1 are given the same signs and their description is omitted.

FIG. 2 is a block configuration diagram for monitoring equipment that measures the quality of a communication network using the output of a mirror port. A mirror port is a port in FIG. 2, from which every time third network equipment 60 sends data to or receives data from network equipment 10, data identical to those sent data or received data are output. In other words, network equipment 60 outputs sending data to network equipment 10 and, at the same time, creates identical sending data and also outputs those identical sending data from the mirror port. Network equipment 60, if it receives data, creates data identical to the received data and outputs those identical received data from the mirror port.

In FIG. 2, network equipment 60 has a Gigabit Ethernet port and is connected to network equipment 10 with a pair of optical fibers 32 so that packet data can be transmitted as optical signals. Network equipment 60 is also connected so that optical signals can be transmitted to monitoring equipment 50 from its mirror port via a pair of optical fibers 33.

Optical signals output from the mirror port of network equipment 60 are input to monitoring equipment 50 by being transmitted through optical fibers 33. This monitoring equipment 50 has first O/E converter 51a, first electro-optical (E/O) converter 55a that converts electrical signals into optical signals, first physical layer circuit 52a, first MAC layer circuit 53a, controller 54, and others.

Each element fiber of optical fibers 33 is connected to the sending end and receiving end of the mirror port of network equipment 60 respectively. The input end of first O/E converter 51a is connected to one element fiber of optical fibers 33 and sending data from network equipment 60 are input to this end. The output end of E/O converter 55a is connected to the other element fiber of optical fibers 33 and outputs receiving data from physical layer circuit 52a to network equipment 60. Physical layer circuit 52a is connected to the output end of O/E converter 51a, to the input end of E/O converter 55a and to MAC layer circuit 53a, and transmits output signals from O/E converter 51a to MAC layer circuit 53a, and also transmits output signals from MAC layer circuit 53a to E/O converter 55a.

The actions of such equipment will be described below. Every time network equipment 60 sends data to or receives data from network equipment 10, network equipment 60 outputs data identical to the sent data or the received data to O/E converter 51a from its mirror port via one element fiber of optical fibers 33.

O/E converter 51a converts optical signals to electrical signals and outputs them to physical layer circuit 52a. Physical layer circuit 52a converts the electrical signals output from O/E converter 51a to logic signals and outputs them to MAC layer circuit 53a. MAC layer circuit 53a acquires the required signals from the logic signals and outputs them to controller 54. Controller 54 measures the quality of the communication network between network equipment using the output signals from MAC layer circuit 53a.

Further, in the case of connection using such a mirror port, controller 54 must negotiate with network equipment 60 for determining communicating conditions by exchanging information including the transfer rate with each other prior to sending or receiving data. Controller 54 also controls this negotiation, creates the information required, converts it to electrical signals according to the standards of Ethernet in MAC layer circuit 53a and physical layer circuit 52a, and outputs the electrical signals to E/O converter 55a. E/O converter 55a converts these electrical signals to optical signals and outputs them to network equipment 10 via the other element fiber of optical fibers 33. Similarly, network equipment 60 outputs the information necessary for negotiation to monitoring equipment 50 via one element fiber of optical fibers 33.

The maximum transmission distance of optical fibers 30 that connect network equipment 10 with network equipment 20 varies with the type of optical fiber and the wavelength of the light source. For example, if multi-mode fiber is used for optical fibers 30 and the wavelength of the light source is about 850 nm, the maximum transmission distance is 550 m. If single-mode fiber is used for optical fibers 30 and the wavelength of the light source is about 1300 nm, the maximum transmission distance is 5000 m. There are many factors which restrict the maximum transmission distance. One of them is the optical power that reaches network equipment 10 and 20. This is because excessive reduction of the optical power of optical signals during transmission through optical fibers 30 makes network equipment 10 and 20 unable to receive optical signals accurately.

However, monitoring equipment 50 requires optical signals passing through optical fibers 30 to be input to it in order to measure the quality of the communication network that is to be measured. As shown in FIG. 4, optical signals are input to monitoring equipment 50 after being split with splitter 40. There is a problem that the optical power reaching network equipment 10 and 20 is reduced due to this splitting and thus the transmission distance over which communication is possible is shortened compared with the original permissible distance.

There is also another problem that, if monitoring equipment 50 is connected to a transmission line configured with the maximum transmission distance or the length close to the maximum transmission distance using splitter 40, accurate communication with network equipment 10 and 20 becomes impossible, which further affects the quality of the communication network.

In addition, if a mirror port is used, there is another problem that outputs from the mirror port cannot be completed within the prescribed time if the capacity of sending and receiving data between network equipment 10 and network equipment 60 is large and so not all the data can be measured. This configuration is not so suitable for measuring the quality of communication networks.

Further, it is also a problem that other receiving equipment cannot be used because monitoring equipment 50 occupies the mirror port.

### SUMMARY OF THE INVENTION

The object of the present invention is to realize monitoring equipment for optical digital communications which can measure the quality of or can acquire data in communication networks without reducing the optical power in communication networks.

### BRIEF DESCRIPTION OF THE DRAWINGS

FIG. 1 is a configuration drawing of conventional monitoring equipment using a splitter.

FIG. 2 is a configuration drawing of conventional monitoring equipment using a mirror port.

FIG. 3 is a configuration drawing showing a first embodiment of the present invention.

FIG. 4 is a configuration drawing showing a second embodiment of the present invention.

FIG. 5 is a configuration drawing showing a third embodiment of the present invention.

### DETAILED DESCRIPTION OF THE PREFERRED EMBODIMENTS

Embodiments of the present invention will be described below using drawings.

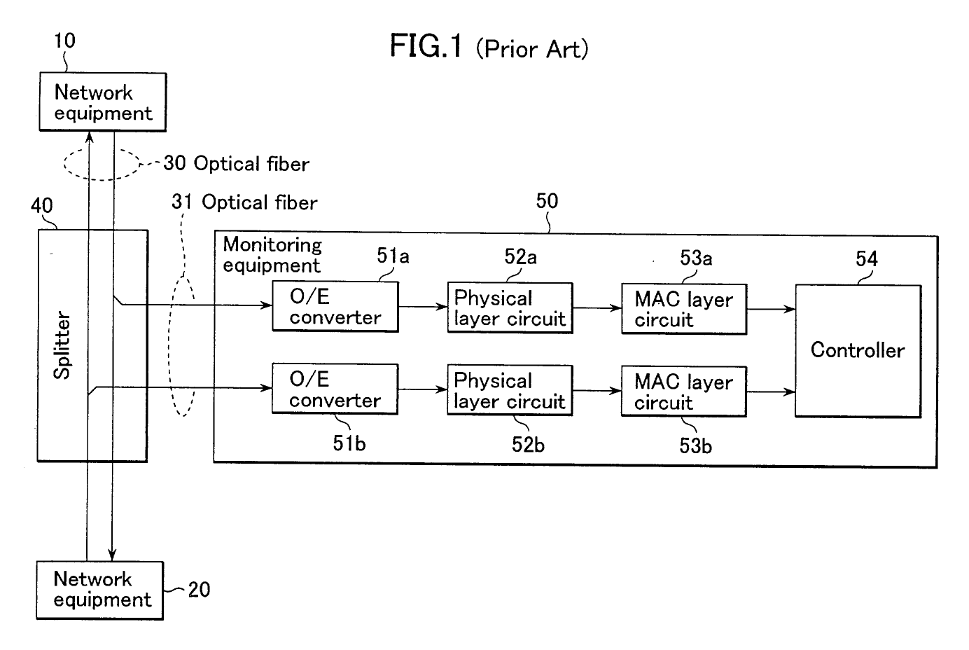

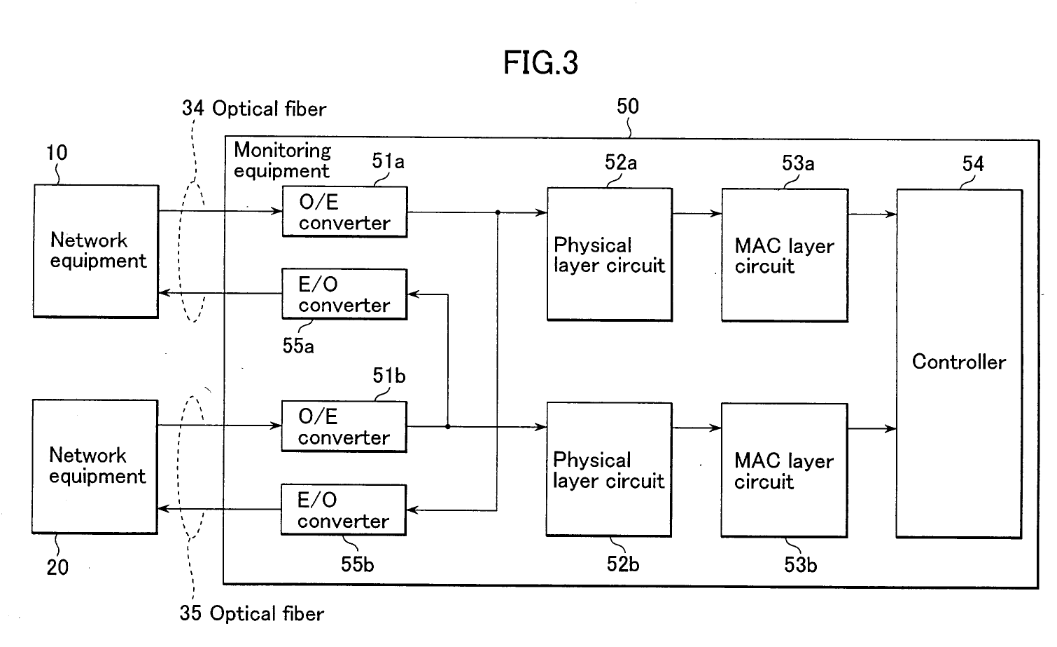

FIG. 3 is a configuration drawing using a block diagram indicating a first embodiment of the present invention. In FIG. 3, the same blocks as those shown in FIG. 1 are given the same sign and thus their description is omitted. In FIG. 3, optical fibers 34 and 35 are provided in lieu of optical fibers 30 and 31 and splitter 40 in FIG. 1. Optical fibers 34 are composed of a pair of fibers and are connected to both network equipment 10 and monitoring equipment 50. One element fiber of optical fibers 34 is connected to the input end of O/E converter 51a and the other element fiber of optical fibers 34 is connected to the output end of E/O converter 55a. Optical fibers 35 are composed of a pair of fibers and connected to both network equipment 20 and monitoring equipment 50. One element fiber of optical fibers 35 is connected to the input end of O/E converter 51b and the other element fiber of optical fibers 35 is connected to the output end of E/O converter 55b.

The input end of first E/O converter 55a is connected to the output end of O/E converter 51b and the output end of E/O converter 55a is connected to the other element fiber of optical fibers 34 and outputs receiving data for network equipment 10. The input end of second E/O converter 55b is connected to the output end of O/E converter 51a and the output end of E/O converter 55b is connected to the other element fiber of optical fibers 35 and outputs receiving data for network equipment 20.

The actions of such equipment will be described below. Data sent from network equipment 10 are input to O/E converter 51a in monitoring equipment 50 via one element fiber of optical fibers 34. O/E converter 51a converts optical signals to electrical signals and outputs the converted electrical signals to physical layer circuit 52a and E/O converter 55b. E/O converter 55b converts electrical signals to optical signals and outputs them to the other element fiber of optical fibers 35. These output signals are input to network equipment 20 as received data.

Data sent from network equipment 20 are input to O/E converter 51b in monitoring equipment 50 via one element fiber of optical fibers 35. O/E converter 51b converts optical signals to electrical signals and outputs the converted electrical signals to physical layer circuit 52b and E/O converter 55a. E/O converter 55a converts electrical signals into optical signals and outputs them to the other element fiber of optical fibers 34. These output signals are input to network equipment 10 as received data. Descriptions of the actions of monitoring equipment 50 subsequent to physical layer circuits 52a and 52b are omitted because they are the same as those of the equipment shown in FIG. 1.

As seen above, optical signals through each element fiber of optical fibers 34 and 35 are converted to electrical signals by O/E converters 51a and 51b and these electrical signals. are output to physical layer circuits 52a and 52b, and to E/O converters 55a and 55b. E/O converters 55a and 55b convert electrical signals to optical signals, output them with sufficient optical power to each other element fiber of optical fibers 34 and 35, and transmit data to network equipment 10 and 20. This makes it possible to measure the quality of a communication network without reducing the optical power transmitted through optical fibers 34 and 35.

In addition, it is not necessary to split light using splitter 40 because each of O/E converters 51a and 51b and E/O converters 55a and 55b in monitoring equipment 50 is directly connected to optical fibers 34 and 35. This can reduce the number of components, and so reduce the cost.

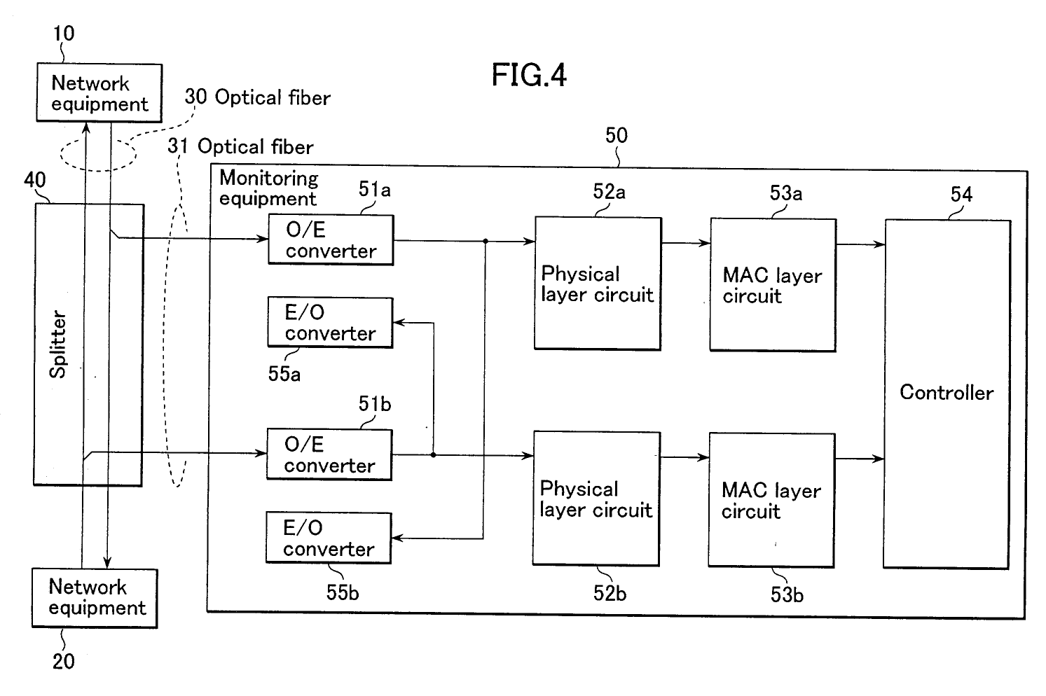

FIG. 4 is a configuration drawing using a block diagram showing a second embodiment of the present invention. In FIG. 4, the same blocks as those shown in FIG. 1 or FIG. 3 are given the same sign and descriptions of them will be omitted. This is an embodiment applied to a measuring system using optical splitter 40.

In FIG. 4, optical signals split by splitter 40 are input to monitoring equipment 50 after being transmitted through optical fibers 31. The input end of first O/E converter 51a is connected to one element fiber of optical fibers 31 through which the sending data from network equipment 10 are transmitted. The input end of second O/E converter 51b is connected to the other element fiber of optical fibers 31 through which the sending data from network equipment 20 are transmitted. Nothing is connected to the output ends of E/O converters 55a and 55b.

The actions of such equipment will be described below. The sending data from network equipment 10 and network equipment 20 are input to O/E converters 51a and 51b respectively via optical fibers 31. O/E converters 51a and 51b convert these input optical signals to electrical signals and output them. Although E/O converter 55a converts the electrical signals output from O/E converter 51b to optical signals while E/O converter 55b converts the electrical signals output from O/E converter 51a to optical signals, nothing is output to network equipment 10 and 20 because nothing is connected to each output end of E/O converters 55a and 55b. Since actions other than for the output ends of E/O converters 55a and 55b are the same as those of the equipment shown in FIG. 3, descriptions of those actions will be omitted.

As described above, the quality of a communication network can be measured using the electrical signals obtained by converting optical signals through optical fibers 30 with O/E converters 51a and 51b. This enables monitoring equipment 50 of the present invention to be applied also to a configuration using splitter 40 for splitting optical signals.

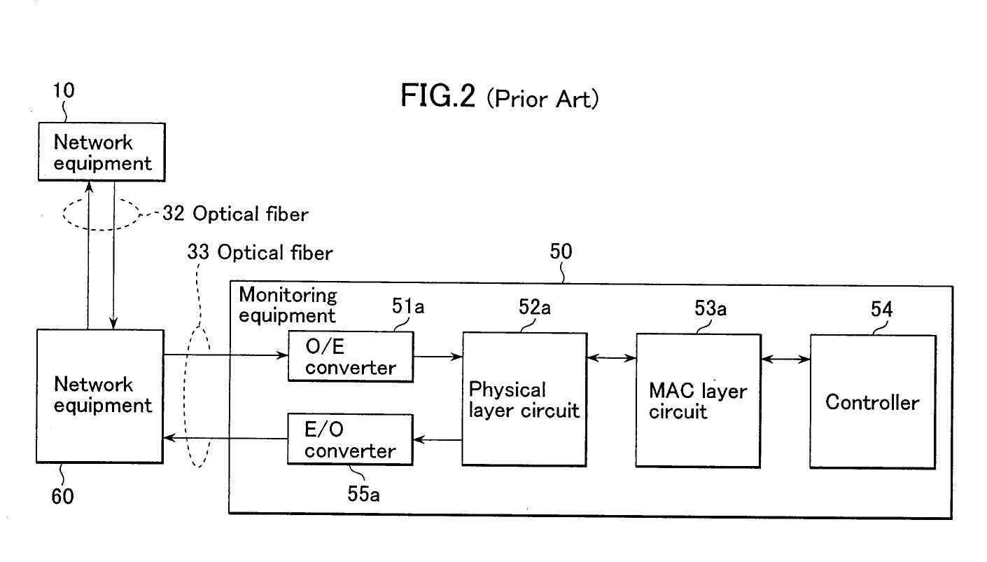

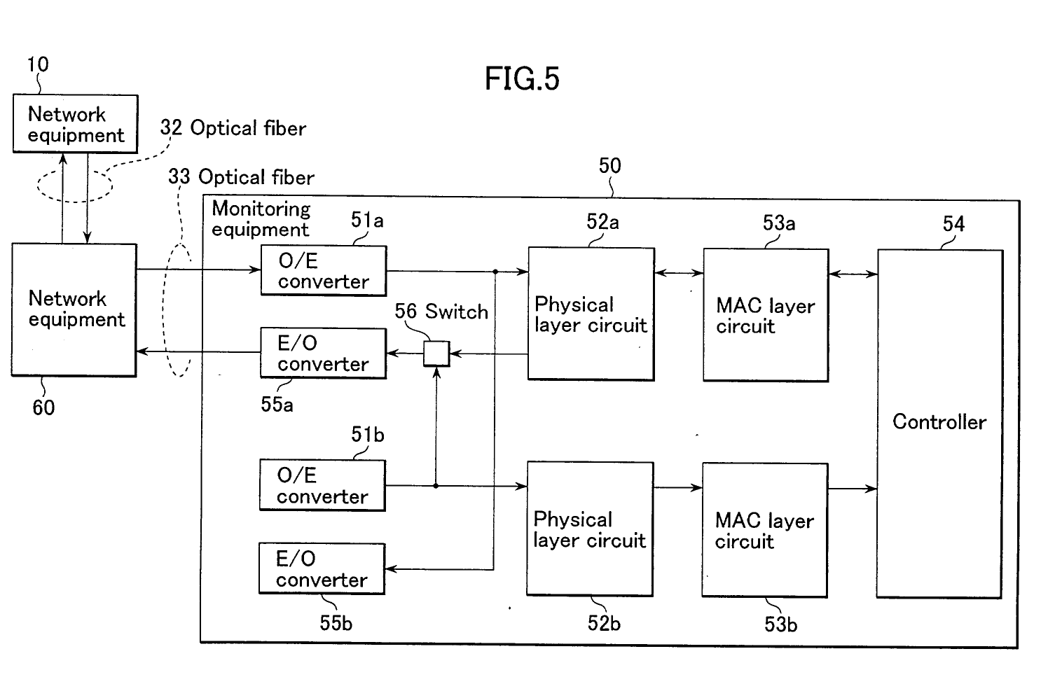

FIG. 5 is a configuration drawing using a block diagram showing a third embodiment of the present invention. In FIG. 5, the same blocks as those shown in FIG. 2 or FIG. 3 are given the same sign and descriptions of them will be omitted. This is an embodiment applied to a measuring system using network equipment having a mirror port.

In FIG. 5, the input end of O/E converter 51a is connected to one element fiber of optical fibers 33 and data are input to O/E converter 51a from network equipment 60. The output end of E/O converter 55a is connected to the other element fiber of optical fibers 33 and outputs information for implementing negotiation to network equipment 60. Switch 56 is provided in monitoring equipment 50 and adds the output of physical layer circuit 52a (output for implementing negotiation with network equipment 60) to the output of O/E converter 51b and outputs the added results to E/O converter 55a.

Nothing is connected to the input end of O/E converter 51b and thus no optical signals are input to O/E converter 51b. Further, nothing is connected to the output end of E/O converter 55b and thus no optical signals are output from E/O converter 55b.

The actions of such equipment will be described below. Controller 54 creates the information necessary for implementing negotiation between controller 54 and network equipment 60. The information is converted to electrical signals by MAC layer circuit 53a and physical layer circuit 52a according to Ethernet standards and these electrical signals are then output to switch 56. Switch 56 adds the output from physical layer circuit 52a to the output from O/E converter 51b and outputs the added results to E/O converter 55a. However, since optical signals are not input to O/E converter 51b, its output should be fixed to the LOW level signal or the HIGH level signal.

Electrical signals are input to E/O converter 55b from O/E converter 51a. Although E/O converter 55b converts input electrical signals to optical signals, nothing is connected to its output end. Thus, no signals are output to network equipment 60.

Since blocks other than these of O/E converter 51b, E/O converter 55b, and switch 56, and actions except those for implementing negotiation, are the same as those shown in FIG. 3, descriptions of those are omitted.

As described above, processing parts of monitoring equipment 50 implement negotiation with network equipment 60 via O/E converter 51a, E/O converter 55a, and optical fibers 33. In addition, the quality of a communication network can be measured by converting sending or receiving data communicated between network equipment 60 and network equipment 10 to electrical signals with O/E converter 51a via one element fiber of optical fibers 33 and using these electrical signals. This enables monitoring equipment 50 of the present invention to be applied to the configuration in which a communication network is measured via special network equipment having a mirror port.

Note that the present invention is not limited to the above usage but may be applied to the usage described below.

The measuring part measures the quality of the communication network in the above description. However, the present invention may take a configuration such that the measuring part acquires only packet data and the quality is measured by analyzing the data with other equipment.

In addition, as network equipment 10 and 20, an example of configuration of a personal computer provided with a Gigabit Ethernet port that can be connected to optical fibers is shown above. However, equipment that is capable of performing optical digital communications may be used, e.g., a personal computer provided with a Fast Ethernet port that can be connected to optical fibers, a router that can be connected to optical fibers, intelligent switch, etc.

Further, although examples in which two units of network equipment are connected are shown in FIG. 3 to FIG. 5, network equipment units 10, 20, and 60 may be connected to other communication units and/or communication networks, and also a plurality of monitoring equipment 50 can be provided in these communication networks.

In FIG. 3 and FIG. 4, the configuration provided with two O/E converters 51a and 51b and two E/O converters. 55a and 55b is shown respectively. However, the configuration provided with only O/E converter 51a and E/O converter 55b may also be employed. In this case, measurement for only one or the other element fiber of a pair of optical fibers 31, 34, or 35 is carried out.

Also in FIG. 4, E/O converters 55a and 55b can be used as ports for connecting other receiving equipment (e.g., logger equipment for data flowing in a communication network) to their output ends via new optical fibers.

In FIG. 5, the configuration may be employed, in which electrical signals are output to E/O converter 55a by selecting the output from physical layer circuit 52a negotiating with network equipment 60 and the output of O/E converter 51b with a selector provided instead of switch 56.

Also in FIG. 5, the configuration provided with two O/E converters 51a and 51b and two E/O converters 55a and 55b is shown. However, the configuration provided with only O/E converter 51a and E/O converter 55b may also be employed, in which an element fiber of optical fibers 33 connected to E/O converter 55a is removed and re-connected to E/O converter 55b and electrical signals are output to E/O converter 55b by switching the output from physical layer circuit 52a (output for implementing negotiation with network equipment 60) to the output of O/E converter 51a or vice versa with a selector.

According to the present invention, the following effects are obtained:

O/E converters convert optical signals in an optical digital communication network to electrical signals, and E/O converters convert these electrical signals to optical signals and output them to the optical digital communication network. At the same time, quality measurement or data acquisition is carried out using the output of O/E converters. This enables the E/O to output optical signals to an optical digital communication network with sufficient optical power, and enables quality measurement or data acquisition for the communication network to be implemented.

Since the measuring part implements negotiation by giving negotiation output to the E/O converter using the negotiation output from the O/E converter, quality measurement of or data acquisition from a communication network can be carried out by sending data to or receiving data from network equipment having a mirror port.

What is claimed is:

1. Monitoring equipment for optical digital communications that measures the quality of optical digital communication networks in which a plurality of network equipment is connected, comprising
at least one O/E converter that converts optical signals transmitted in said optical digital communication networks to electrical signals, and
at least one E/O converter that converts electrical signals from this O/E converter to optical signals and outputs these optical signals to said optical digital communication networks,
and measuring said quality using the output of said O/E converter.

2. Monitoring equipment for optical digital communications that acquires data in optical digital communication networks in which a plurality of network equipment is connected, comprising
at least one O/E converter that converts optical signals transmitted in said optical digital communication networks to electrical signals, and
at least one E/O converter that converts electrical signals from this O/E converter to optical signals and outputs these optical signals to said optical digital communication networks,
and acquiring said data using the output of said O/E converter.

3. Monitoring equipment for optical digital communications in accordance with claim 1 or claim 2, wherein a measuring part that implements measurement or data acquisition using the output of an O/E converter is provided.

4. Monitoring equipment for optical digital communications in accordance with claim 3, wherein said measuring part implements negotiation for determining conditions for communicating with network equipment by sending out the negotiation output to an E/O converter and using the negotiation output from said O/E converter.

5. Monitoring equipment for optical digital communications in accordance with claim 4, wherein a selector is provided, which outputs either of said negotiation output from said measuring part and the output of said O/E converter to said E/O converter by selecting them.

6. Monitoring equipment for optical digital communications in accordance with claim 4, wherein two O/E converters and two E/O converters are provided respectively, a switch which adds said negotiation output from said measuring part to the output of the second O/E converter and outputs the added results to the first E/O converter is equipped, and said negotiation is implemented by the first O/E converter and the first E/O converter.
